(19) United States
(12) Patent Application Publication
(10) Pub. No.: US 2026/0010449 A1
(43) Pub. Date: Jan. 8, 2026

(54) SYSTEM ON A CHIP, TEST DEVICE FOR TESTING SYSTEM ON A CHIP AND TEST METHOD THEREOF

(71) Applicant: ASPEED Technology Inc., Hsinchu City (TW)

(72) Inventors: Chin-Ting Kuo, Hsinchu City (TW); Shih-Fang Chen, Hsinchu City (TW); Chih-Chiang Mao, Hsinchu City (TW); Hung Liu, Hsinchu City (TW)

(73) Assignee: ASPEED Technology Inc., Hsinchu City (TW)

(21) Appl. No.: 18/923,725

(22) Filed: Oct. 23, 2024

(30) Foreign Application Priority Data
Jul. 3, 2024 (TW) 113124793

(51) Int. Cl. G06F 11/273; G06F 11/22

(52) U.S. Cl. CPC G06F 11/273; G06F 11/2236

(57) ABSTRACT

A System on a Chip (SoC), a test device for testing the SoC, and a test method for testing the SoC are provided. The SoC includes a function register, a one-time programmable (OTP) memory, and a processor. The function register includes functional bits. The SoC performs a test operation based on data of at least one of the functional bits. The OTP memory includes setting bits and operating bits. When a bit value of a first setting bit among the setting bits is a first value, the SoC writes data coming from a first operating bit among the operating bits to a first functional bit among the functional bits. When the bit value of the first setting bit is the second value, the SoC writes a first bit value of the test data to the first functional bit.

### CROSS-REFERENCE TO RELATED APPLICATION

This application claims the priority benefit of Taiwan application serial no. 113124793, filed on Jul. 3, 2024. The entirety of the above-mentioned patent application is hereby incorporated by reference herein and made a part of specification.

### BACKGROUND

### Technical Field

The disclosure relates to a System on a Chip, a test device for testing System on a Chip, and a test method thereof, and in particular, to a System on a Chip, a test device, and a test method that can reduce testing costs.

### Related Art

Generally speaking, System on a Chip (SoC) has different capabilities, functions or operating behaviors based on different combinations of one-time programmable (OTP) memory configurations. Before shipment, multiple and diverse functional tests are executed. During testing and development stages, the SoC will be tested multiple times and in various ways with different OTP memory configurations in order to meet various application scenarios. Due to OTP's physical characteristics, OTP memory cannot be overwritten, generally speaking, the value of a physical OTP memory bit can only be changed or configured once in a single SoC, corresponding to one function or one application scenario. Thus, during testing and development stages, a large number of the chips will be consumed and considerable costs will be increased.

### SUMMARY

The disclosure provides a System on a Chip, a test device, and a test method that can reduce testing costs.

In an embodiment of the disclosure, the System on a Chip (SoC) includes a function register, an one-time programmable (OTP) memory, and a processor. The function register includes multiple functional bits. A SoC has different functions or operating behaviors based on the configuration of the function register. During a test process, a test operation is executed on the SoC based on the data of at least one of the multiple functional bits. The OTP memory includes multiple setting bits and multiple operating bits. The processor is coupled to the function register and the function register is coupled to the OTP memory. The processor receives test data during a test stage. When the bit value of the first setting bit among the multiple setting bits is the first value, the SoC writes data coming from the first operating bit among the multiple operating bits into the first functional bit among the multiple functional bits. When the bit value of the first setting bit is the second value, the SoC writes the first bit value of the test data into the first functional bit among the multiple functional bits.

In an embodiment of the disclosure, a test device is suitable for testing a SoC. The SoC includes an OTP memory. The OTP memory includes multiple setting bits. The test device includes an input unit, a test data memory, and a processor. The processor is coupled to the test data memory. The processor receives multiple test data coming from outside, writes the multiple test data into the test data memory, selects the tested data from the multiple test data in response to operation of the input unit, and provides the selected test data to the SoC by a transmission protocol. The SoC receives the selected test data based on the transmission protocol, selects partial bit values of the test data based on the bit values of the multiple setting bits, and a test operation is executed on the SoC based on the partial bit values.

In an embodiment of the disclosure, the test method is suitable for testing a SoC. The SoC includes a function register and an OTP memory. The function register includes multiple functional bits. The SoC has different functions or operating behaviors based on the configuration of the function register. The OTP memory includes multiple setting bits and multiple operating bits. The test method includes, receiving test data by the SoC; when the bit value of the first setting bit among the multiple setting bits is the first value, writing data coming from the first operating bit among the multiple operating bits into the first functional bit among the multiple functional bits; when the bit value of the first setting bit is the second value, writing the first bit value of the test data into the first functional bit among the multiple functional bits; and a test operation is executed by the SoC based on data of at least one of the multiple functional bits.

According to the above, the SoC writes one of the first test data bit value and the first operating bit value in the OTP memory into the first functional bit among the multiple functional bits based on the bit value of the first setting bit. It should be noted that when the bit value of the first setting bit is the second value, the SoC writes the first bit value of the test data into the first functional bit among the multiple functional bits. Thus, during the SoC testing process, through the combination of test data and setting bits, the number of real OTP memory programming times can be reduced. The OTP memory consumption can be reduced. In this way, the test cost of the SoC can be reduced during the test and the development stages.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a test system according to an embodiment of the disclosure.

FIG. 2 is a flow chart of a test method according to an embodiment of the disclosure.

FIG. 3 is a schematic diagram showing the setting of a function register according to an embodiment of the disclosure.

FIG. 4 is a flow chart of a test method according to an embodiment of the disclosure.

FIG. 5 is a schematic diagram of a test device according to an embodiment of the disclosure.

FIG. 6 is a schematic diagram showing the setting of a function register according to an embodiment of the disclosure.

FIG. 7 is a flow chart of a test method according to an embodiment of the disclosure.

FIG. 8 is a schematic diagram of a System on a Chip according to an embodiment of the disclosure.

FIG. 9 is a schematic diagram showing the setting of a function register according to an embodiment of the disclosure.

FIG. 10 is a schematic diagram of the appearance of a test device according to an embodiment of the disclosure.

FIG. 11 is a schematic diagram of a transmission protocol and test data according to an embodiment of the disclosure.

FIG. 12 is a schematic diagram of the operation of a test system according to an embodiment of the disclosure.

### DESCRIPTION OF THE EMBODIMENTS

Some embodiments of the disclosure will be described in detail with reference to the accompanying drawings. The component symbols cited in the following description will be regarded as the same or similar components when the same component symbols appear in different drawings. These embodiments are only part of the disclosure and do not disclose all possible implementations of the disclosure. Rather, these embodiments are only examples within the scope of the patent application of the disclosure.

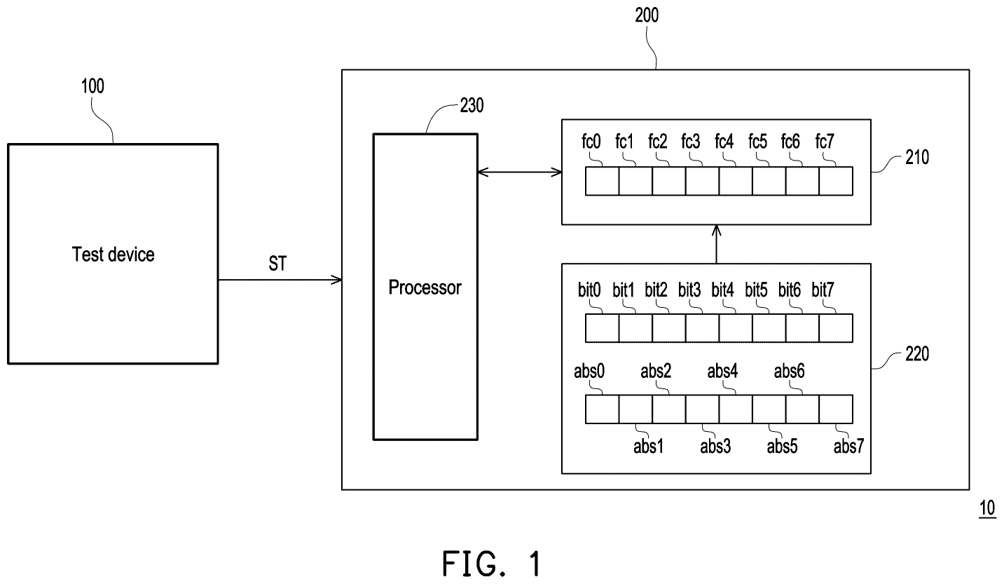

Please refer to FIG. 1. FIG. 1 is a schematic diagram of a test system according to an embodiment of the disclosure. In the embodiment, a test system 10 includes a test device 100 and a System on a Chip (SoC) 200. The test device 100 is suitable for testing SoC 200. In the embodiment, the SoC 200 includes a function register 210, a one-time programmable (OTP) memory 220 and a processor 230. The function register 210 includes functional bits fc0-fc7. A test operation may be executed by the SoC based on the data of at least one of the functional bits fc0-fc7. For example, when the data of the functional bit fc1 is “0” and the data of the functional bit fc2 is “0”, a test operation with the first frequency, e.g., 1.6 GHz, may be executed on the SoC 200, but the disclosure is not limited thereto. For example, when the data of the functional bit fc1 is “0” and the data of the functional bit fc2 is “1”, a test operation with the first frequency, e.g., 1.2 GHz, may be executed on the SoC 200, but the disclosure is not limited thereto.

In the embodiment, the OTP memory 220 is coupled to the function register 210. The OTP memory 220 includes setting bits abs0-abs7 and operating bits bit0-bit7. The setting bits abs0-abs7 correspond to the functional bits fc0-fc7 in a one-to-one manner, but the disclosure is not limited thereto.

In the embodiment, the processor 230 is coupled to the function register 210. The processor 230 receives test data ST during the test stage. Taking the setting bit abs0 as an example, when the bit value of the setting bit abs0 is the first value, the SoC 200 writes the data coming from the operating bit bit0 into the functional bit fc0.

In the embodiment, the setting bits abs0-abs7 and the operating bits bit0-bit7 of the OTP memory 220 may be implemented by electronic fuse units respectively, but the disclosure is not limited thereto. When the electronic fuse of the operating bit bit0 is blown, the operating bit bit0 is the first value. The first value may be the numerical value “1”. On the other hand, when the electronic fuse of the operating bit bit0 is not blown out, the operating bit bit0 is the second value. The second value may be the numerical value “0”. When the electronic fuse of the setting bit abs0 is blown, the setting bit abs is the first value. The first value may be the numerical value “1”. When the electronic fuse of the setting bit abs0 is not blown, the setting bit abs0 is the second value. The second value may be the numerical value “0”.

When the bit value of the setting bit abs0 is the second value, the processor 230 may write the first bit value of the test data ST into the functional bit fc0.

Hence, the SoC 200 may write one of the first bit value of the test data or the data of the operating bit bit0 into the functional bit fc0 according to the bit value of the setting bit abs0. Similarly, the SoC 200 may write one of the second bit value of the test data or the data of the operating bit bit1 into the functional bit fc1 according to the bit value of the setting bit abs1, and so on.

It is worth mentioning here that when the bit value of one of the setting bits abs0-abs7 is the second value, the SoC 200 writes the corresponding bit value of the test data ST into the corresponding functional bit among the functional bits fc0-fc7. Thus, during testing of the SoC 200, the times for programming OTP memory 220 can be reduced. The OTP memory 220 consumption is reduced. In this way, the testing cost of the SoC 200 during the test and development stages can be reduced.

In the embodiment, the processor 230 is, for example, a Central Processing Unit (CPU), or other programmable general-purpose or special-purpose Microprocessor, Digital Signal Processor (DSP), programmable controller, Application-Specific Integrated Circuit (ASIC), Programmable Logic Device (PLD) or other similar devices or a combination of these devices, which may load and execute programs.

It is worth mentioning that in some embodiments, the functional bit 210 may be a physical register (register), in the SoC 200, a dynamic random access memory (DRAM), a static random access memory (SRAM), or a one-dimensional or two-dimensional array configured by the software, but the disclosure is not limited thereto.

For ease of explanation, the number of bits of the functional bits fc0-fc7 of the function register 210 in the embodiment is taken as 8. In the embodiment, the number of bits of setting bits abs0-abs7 and the number of bits of the operating bits bit0-bit7 of the OTP memory 220 are 8 respectively. The number of bits of functional bits, the number of bits of setting bits, and the number of bits of operating bits of the disclosure are multiple, and are not limited thereto embodiment.

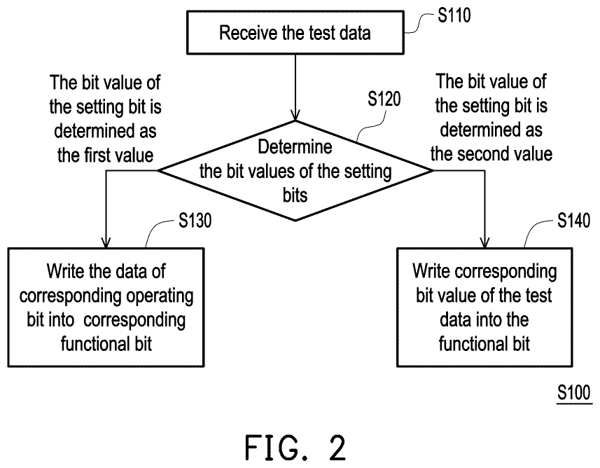

Please refer to FIG. 1 and FIG. 2. FIG. 2 is a flow chart of a test method according to an embodiment of the disclosure. In the embodiment, a test method S100 is suitable for testing the SoC 200. The test method S100 includes steps S110 to S140. In step S110, the SoC 200 receives the test data ST. In step S120, the SoC 200 determines the bit values of the setting bits abs0-abs7. When the bit value of the setting bit abs0 (i.e. the setting bit is determined) is the first value, the SoC 200 writes the data of the operating bit bit0 into the functional bit fc0 in step S130. On the other hand, when the bit value of the setting bit abs0 is the second value, the SoC 200 writes the corresponding bit value of the test data ST into the functional bit fc0 in step S140.

When the bit value of the setting bit abs1 is the first value, the SoC 200 writes the data of the operating bit bit1 into the functional bit fc1 in step S130. On the other hand, when the bit value of the setting bit abs1 is the second value, the SoC 200 writes the corresponding bit value of the test data ST into the functional bit fc1 in step S140, and so on.

Other implementation details of steps S110 to S140 have been clearly explained in the embodiment of FIG. 1 and will not be repeated here. In the embodiment, steps S130 and S140 may be executed by the processor 230 or a setting circuit in the SoC 200.

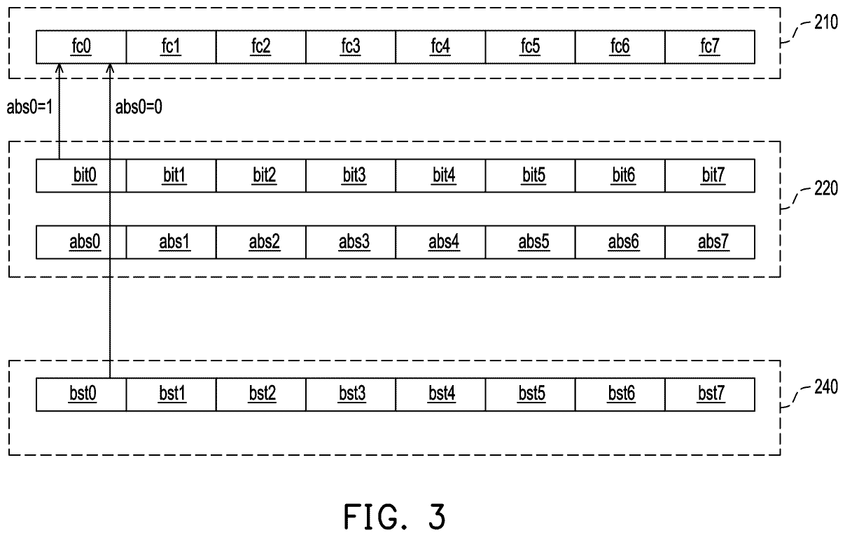

Please refer to FIG. 1 and FIG. 3. FIG. 3 is a schematic diagram showing the setting of the function register according to an embodiment of the disclosure. In the embodiment, the SoC 200 further includes a test data memory 240. The test data memory 240 is coupled to the function register 210. The test data memory 240 stores the test data ST of the System on a Chip 200. The test data ST stored in the test data memory 240 includes bit values bst0-bst7. In some embodiments, the test data ST does not have to be input externally to the SoC 200, and software or firmware can also set the test data memory 240 through the processor 230 directly.

In the embodiment, taking the setting bit abs0 as an example, during the test stage, when the SoC 200 is reset (e.g. warm reset) and the bit value of the setting bit abs0 is the first value, the SoC 200 writes the data of the operating bit bit0 into the corresponding functional bit fc0. It should be noted that once the bit value of the setting bit abs0 is the first value, due to the characteristics of the OTP memory, the bit value of the setting bit abs0 cannot be restored to the second value. Thus, the functional bit fc0 is always the value of the operating bit bit0, which cannot be affected by the test data, and the bit value of the operating bit bit0 is protected from being tampered with.

On the other hand, when the SoC 200 is reset and the bit value of the setting bit abs0 is the second value, the SoC 200 writes the bit value bst0 of the test data ST stored in the test data memory 240 into the functional bit fc0. It should be noted that when the bit value of the setting bit abs0 is the second value, the data of the functional bit fc0 is equal to the bit value bst0. Thus, when the bit value of the setting bit abs0 is the second value, the functional bit fc0 may change as the bit value bst0 changes, thereby increasing the test times of a SoC 200.

In the embodiment, while the SoC 200 is running, the test data ST is one-time written into the test data memory 240. When the SoC 200 is reset, the test data ST stored in the test data memory 240 may be maintained. On the contrary, when the SoC 200 performs a power-on procedure or a cold reset, the test data memory 240 will be initialized to the default value set by the hardware. The test data memory 240 may be a dynamic memory, a volatile register or a volatile memory, but the disclosure is not limited thereto.

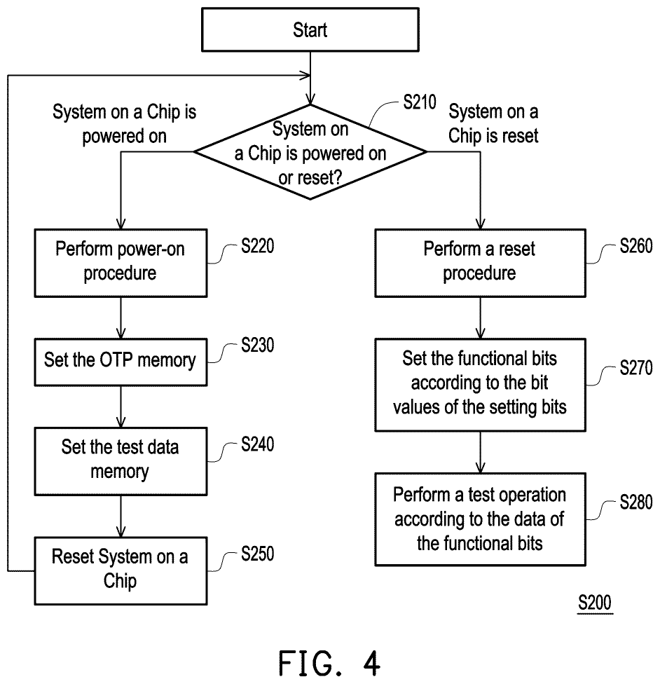

Please refer to FIGS. 1, 3 and 4. FIG. 4 is a flow chart of a test method according to an embodiment of the disclosure. A test method S200 is applicable to the embodiment of FIG. 3.

In the embodiment, the test method S200 includes steps S210 to S280. In step S210, it is determined whether the SoC 200 is powered on or reset. For example, whether the SoC 200 is powered on or reset may be known through signals or commands. When it is determined that the SoC 200 is powered on, the SoC 200 performs the power-on procedure in step S220. The SoC 200 sets the OTP memory 220 in step S230 and sets the test data memory 240 in step S240. In step S240, the processor 230 may write the test data ST into the test data memory 240.

After the setting of the test data memory 240 is completed, the SoC 200 is reset in step S250. For example, a warm reset operation is triggered on the SoC 200 in step S250 and the SoC 200 returns to step S210. Next, the SoC 200 performs a reset procedure in step S260. The test data ST stored in the test data memory 240 is maintained during the reset procedure. In step S270, the SoC 200 sets the functional bits fc0-fc7 according to the bit values of the setting bits abs0-abs7. Step S270 may be implemented by steps S120 to S140 in FIG. 2. Next, a test operation is executed on SoC 200 according to the data of the functional bits fc0-fc7 in step S280.

In the embodiment, if the OTP memory 220 has been set, and step S230 may be omitted.

In some embodiments, if the test data memory 240 in FIG. 3 is composed of a static memory or a non-volatile memory, step S240 in FIG. 4 only needs to be executed once for the same set of test data. If step S230 has also been set, for the same set of test data, steps S220 to S250 only need to be executed once, and after the next power-on, the SoC 200 may directly execute steps S270 and S280 in addition to the power-on procedure.

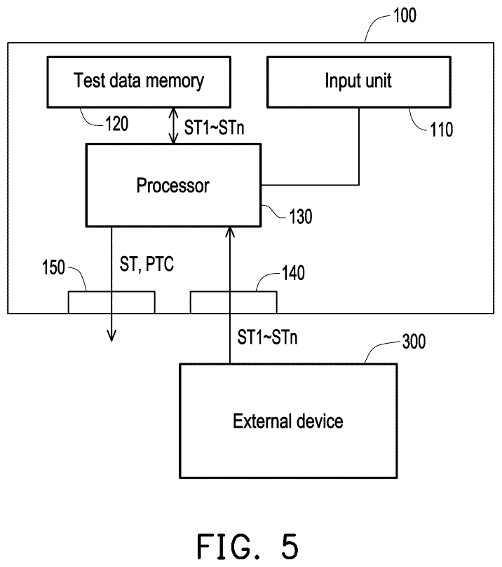

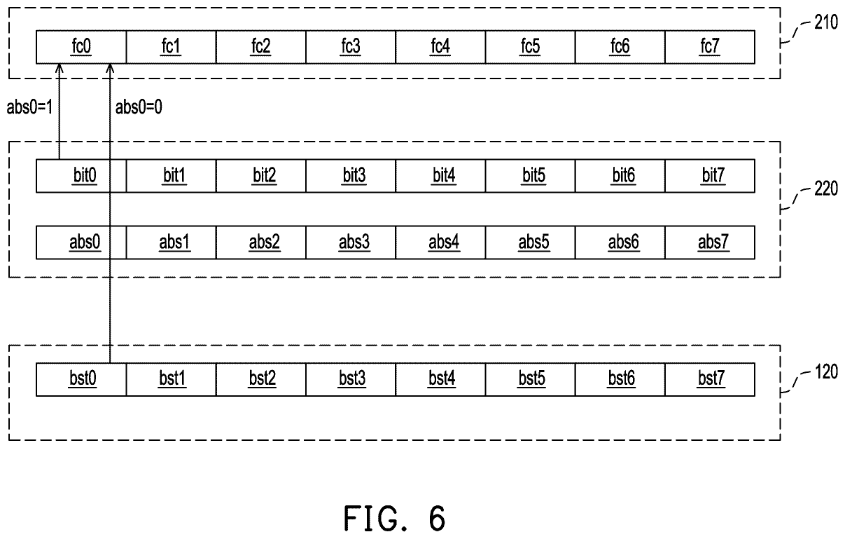

Please refer to FIG. 1, FIG. 5 and FIG. 6. FIG. 5 is a schematic diagram of a test device according to an embodiment of the disclosure. FIG. 6 is a schematic diagram showing the setting of a function register according to an embodiment of the disclosure. In the embodiment, the test device 100 includes an input unit 110, a test data memory 120 and a processor 130. The input unit 110 includes multiple keys, multiple buttons or operation transmission ports in any form. The processor 130 is coupled to the test data memory 120. The processor 130 receives test data ST1-STn coming from outside. The processor 130 writes the test data ST1-STn into the test data memory 120. The processor 130 selects the test data ST (i.e. the selected test data) from the test data ST1-STn in the test data memory 120 in response to the operation of the input unit 110. The processor 130 provides the test data ST to the SoC 200 based on a transmission protocol PTC.

In the embodiment, the test data memory 120 may be a dynamic memory, a volatile register, a volatile memory or a non-volatile memory, but the disclosure is not limited thereto.

The SoC 200 receives the test data ST according to the transmission protocol PTC, selects partial bit values of the test data ST according to the bit values of the setting bits abs0-abs7, and the test operation is executed according to the partial bit values. Furthermore, the SoC 200 may use the bit value bst0 in the test data memory 120 of the test device 100 or the bit value of the operating bit bit0 in the OTP memory 220 as the data of the functional bit fc0 according to the bit value of the setting bit abs0, and use the bit value bst1 in the test data memory 120 of the test device 100 or the bit value of the operating bit bit1 in the OTP memory 220 as the data of the functional bit fc1 according to the bit value of the setting bit abs1, and so on.

Taking the data of the functional bit fc0 as an example, when the bit value of the setting bit abs0 is the first value, the SoC 200 writes the data of bit of the OTP memory 220 into the corresponding functional bit fc0. When the bit value of the setting bit abs0 is the second value, the SoC 200 writes the data of the bit value bit0 in the test data memory 120 of the test device 100 into the corresponding functional bit fc0.

In the embodiment, the test device 100 further includes transmission ports 140 and 150. The transmission ports 140 and 150 are coupled to the processor 130. The processor 130 receives the test data ST1-STn coming from an external device 300 through the transmission port 140, and provides the test data ST to the SoC 200 based on the transmission protocol PTC through the transmission port 150. In the embodiment, the transmission ports 140 and 150 may respectively be transmission elements that comply with one of UART, USB, and GPIO transmission protocols, but the disclosure is not limited thereto.

In the embodiment, the processor 130 is, for example, a Central Processing Unit (CPU), or other programmable general-purpose or special-purpose Microprocessor, Digital Signal Processor, (DSP), programmable controller, Application-Specific Integrated Circuit (ASIC), Programmable Logic Device (PLD) or other similar devices or a combination of these devices, which may load and execute programs.

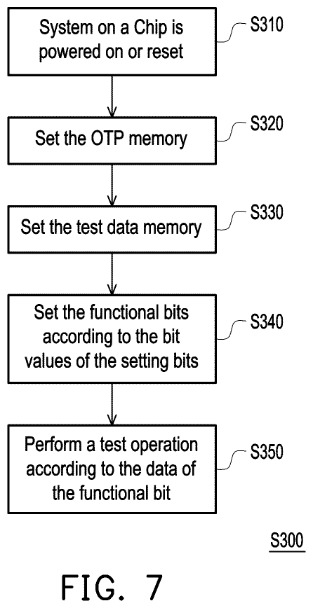

Please refer to FIG. 1 and FIG. 7. FIG. 7 is a flow chart of a test method according to an embodiment of the disclosure. In the embodiment, a test method S300 includes steps S310 to S350. In step S310, the SoC 200 is powered on or reset. The SoC 200 sets the OTP memory 220 in step S320 and sets the test data memory 240 in step S330. In step S340, the SoC 200 sets the functional bits fc0-fc7 according to the bit values of the setting bits abs0-abs7. Step S340 may be implemented by steps S120 to S140 as shown in FIG. 2. Next, a test operation is executed on SoC 200 according to the data of the functional bits fc0-fc7 in step S350.

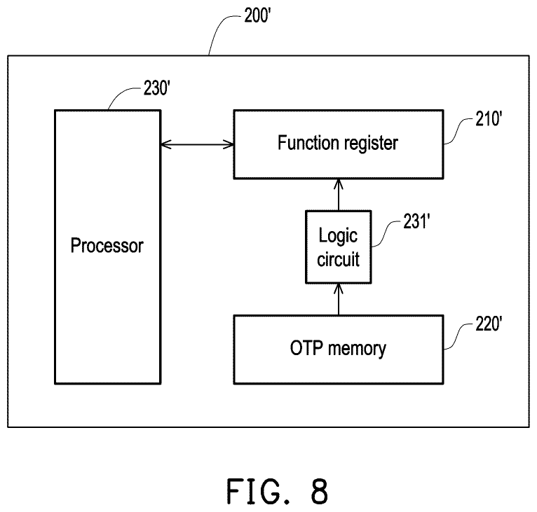

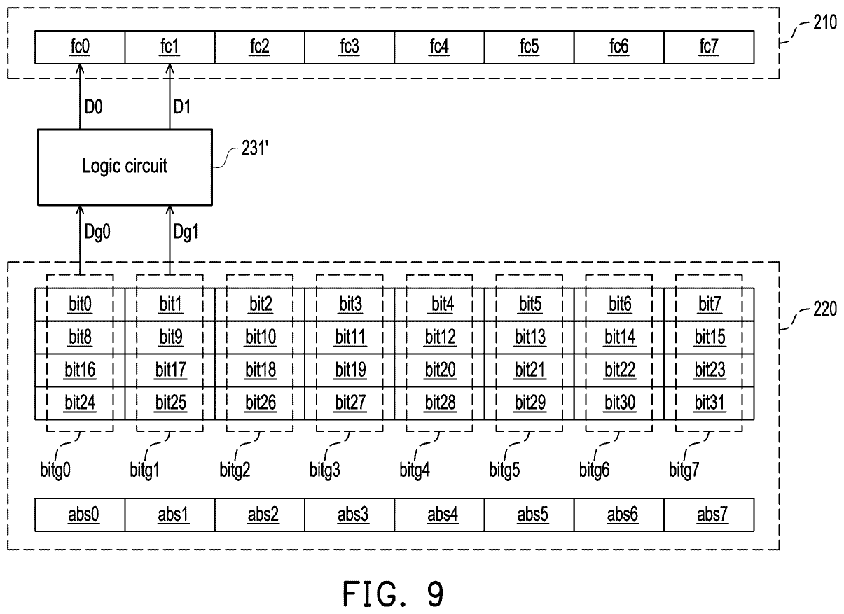

Please refer to FIG. 8 and FIG. 9. FIG. 8 is a schematic diagram of a SoC according to an embodiment of the disclosure. FIG. 9 is a schematic diagram showing the setting of a function register according to an embodiment of the disclosure. In the embodiment, a SoC 200′ includes a function register 210′, an OTP memory 220′ and a processor 230′. The function register 210′ includes the functional bits fc0-fc7. The OTP memory 220′ includes setting bits abs0-abs7 and operating bits bit0-bit31. The operating bits bit0, bit8, bit16, and bit24 are grouped into an operating bit group bitg0. The operating bits bit1, bit9, bit17, and bit25 are grouped into an operating bit group bitg1, and so on. Thus, in the embodiment, operating bit groups bitg0-bitg7 are generated. Taking the operating bit group bitg0 as an example, when the bit value of the setting bit abs0 is the first value, a logical operation is processed on SoC 200′ based on data Dg0 coming from the operating bit group bitg0 to generate data D0 (i.e. operating bit data D0). The SoC 200′ writes the data D0 into the functional bit fc0. Taking the operating bit group bitg1 as an example, when the bit value of the setting bit abs1 is the first value, a logical operation is processed on SoC 200′ based on data Dg1 coming from the operating bit group bitg1 to generate the data D1 (i.e. operating bit data). The SoC 200′ writes the data D1 into the functional bit fc1.

In the embodiment, the SoC 200′ includes a logic circuit 231′. The logic circuit 231′ receives the data Dg0 sequence during the test stage, and performs an exclusive OR (XOR) logical operation on the data Dg0 to generate the data D0.

For example, taking the generation of data D0 as an example, the logic circuit 231′ may first perform XOR logical operation on the data of the operating bits bit0 and bit8 to generate the first logical operation data, perform XOR logical operation on the first logical operation data and the data of the operating bit bit16 to generate the second logical operation data, and perform XOR logical operation on the second logical operation data and the data of the operating bit bit16 to generate the data D0 (i.e. third logical operation data).

It should be noted that the operating bit groups bitg0-bitg7 each include 4 operating bits. Thus, the data D0 and D1 may be changed for the maximum 4 times each. In other words, the number of programming times of the OTP memory 220′ can therefore be increased.

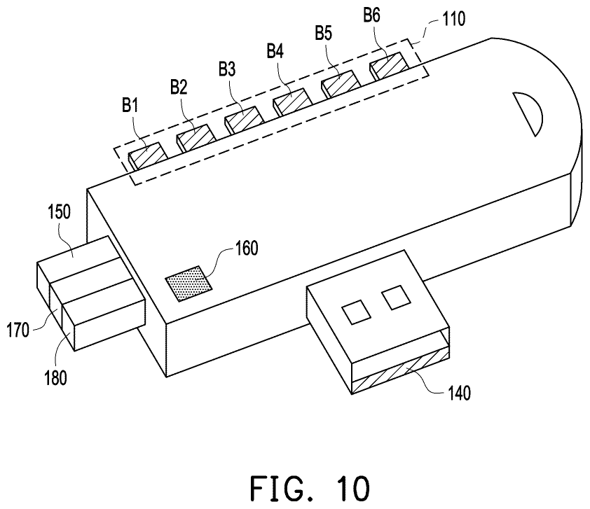

Please refer to FIG. 5 and FIG. 10. FIG. 10 is a schematic diagram of the appearance of a test device according to an embodiment of the disclosure. In the embodiment, the test device 100 further includes a status prompt element 160 and power ports 170 and 180.

When the test device 100 is connected to the SoC 200 through the transmission port 150, the power port 170 may receive power from the SoC 200. The power port 180 may be connected to a ground of the SoC 200. Thus, when the test device 100 is connected to the SoC 200 through the transmission port 150, the test device 100 may be driven by the power of the SoC 200. In other embodiments, the test device 100 may also be independently powered by its own battery power source or powered by the platform board including SoC 200, but the disclosure is not limited thereto.

The status prompt element 160 may be implemented by at least one light-emitting element in any form. The light-emitting element is, for example, a light-emitting diode. The status prompt element 160 may provide different light signals according to different statuses of the test device 100. For example, when the test device 100 is idle, the status prompt element 160 provides the first light signal (e.g. green light). When an abnormality occurs in the connection between the test device 100 and the external device 300, the status prompt element 160 provides the second light signal (e.g. red light). When the test device 100 is transmitting the test data ST to the SoC 200 based on the transmission protocol PTC, the status prompt element 160 provides the third optical signal (e.g. flashing blue light). When the transmission of the test data ST is completed, the status prompt element 160 provides the fourth light signal (e.g. green light that flashes three times).

The input unit 110 includes buttons B1 to B6. For example, when the button B1 is selected, the processor 130 selects the test data ST1 as the test data ST to be provided to the SoC 200 (i.e. the selected test data). For example, when the button B2 is selected, the processor 130 selects the test data ST2 as the test data ST to be provided to the SoC 200 (i.e. the selected test data). The processor 130 generates the test data ST and provides it to the SoC 200 based on the transmission protocol PTC.

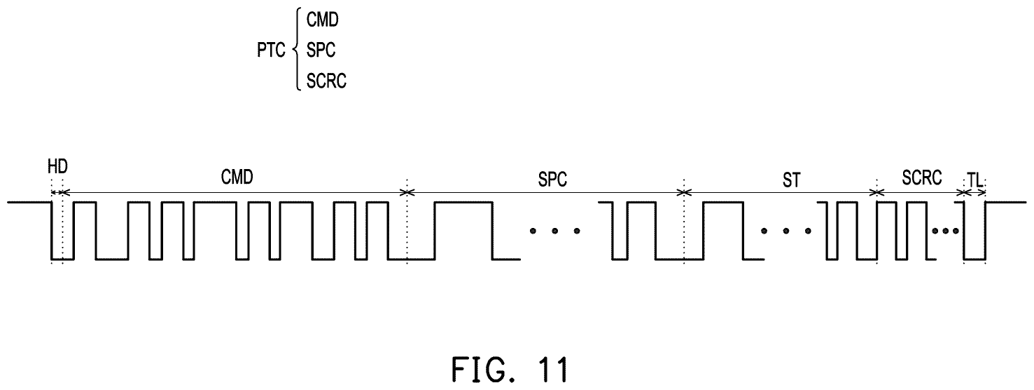

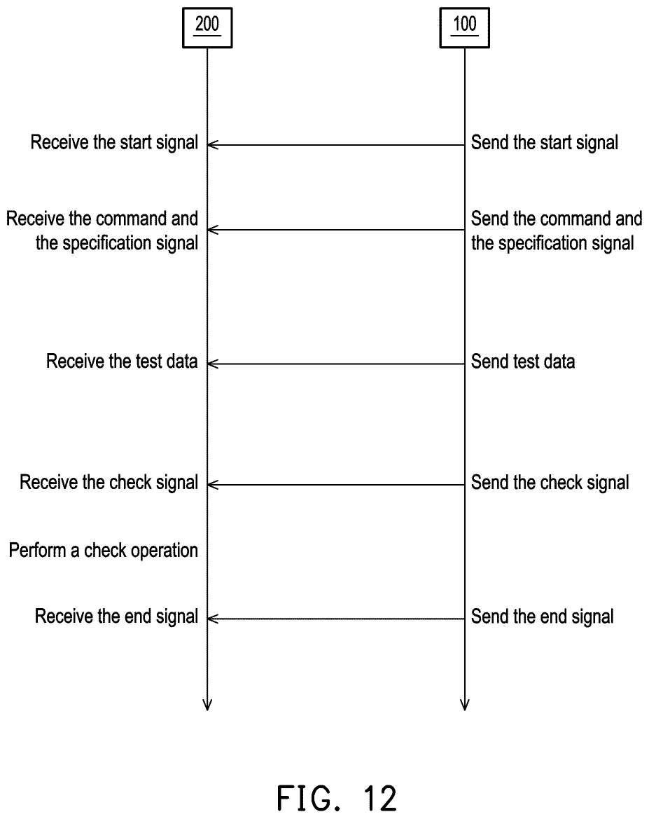

Please refer to FIG. 10, FIG. 11 and FIG. 12. FIG. 11 is a schematic diagram of the transmission protocol PTC and test data according to an embodiment of the disclosure. FIG. 12 is a schematic diagram of the operation of a test system according to an embodiment of the disclosure. In the embodiment, the transmission protocol PTC includes a command CMD, a specification signal SPC of the test data ST, and a check signal SCRC of the test data ST. The specification signal SPC may represent the quantity of test data ST and the number of bits of the test data ST. The check signal SCRC includes check or integrity information of the test data ST.

In the embodiment, when the test device 100 is connected to the SoC 200 through the transmission port 150, the test device 100 waits for a response from the SoC 200. When the SoC 200 is ready, the test device 100 may first send a start signal HD. The SoC 200 receives the start signal HD and learns that the test device 100 is about to send the command CMD according to the start signal HD. The test device 100 sends the command CMD and the specification signal SPC in the following. The SoC 200 receives the command CMD and the specification signal SPC. The SoC 200 learns that the test data ST will be received according to the command CMD, and learns that the received quantity of the test data ST and the number of bits of each test data ST according to the specification signal SPC. For example, the number of the test data ST may be one or more (i.e. at least one of the test data ST1-STn).

Next, the test device 100 sends the test data ST. The SoC 200 receives the test data ST. The SoC 200 has obtained the received number of the test data ST and the number of bits of each test data ST according to the specification signal SPC. Thus, the SoC 200 may receive the complete test data ST.

Next, the test device 100 sends the check signal SCRC. The SoC 200 receives the check signal SCRC, and a check integrity operation of the test data ST is processed according to the check signal SCRC. The check operation may be, for example, a cyclic redundancy check (CRC) operation, but the disclosure is not limited thereto.

Next, the test device 100 sends an end signal TL. The SoC 200 receives the end signal TL and learns that the receiving process of the test data ST is completed.

In the embodiment, based on the waveform of FIG. 11, the transmission port 150 may use only a single pin to transmit the start signal HD, the transmission protocol PTC, the test data ST and the end signal TL. Thus, in one embodiment, the transmission port 150 may be implemented by a single pin, but the disclosure is not limited thereto.

In one embodiment, the transmission port 150 may be implemented by a GPIO transmission port, but the disclosure is not limited thereto. In the embodiment, when the test device 100 is connected to the SoC 200 through the transmission port 150, the test device 100 waits for a response from the SoC 200. When the SoC 200 is ready, the SoC 200 pulls down the voltage value of a specific pin of the transmission port 150 to a low voltage level. The test device 100 may learn that the SoC 200 is ready based on the low voltage level of the specific pin of the transmission port 150. Thus, the test device 100 sends the start signal HD to the System on a Chip 200.

In summary, the SoC of the disclosure writes either the first bit value of the test data or the first operating bit value in the OTP memory into the first functional bit among the multiple functional bits according to the bit value of the first setting bit. It is worth mentioning here that when the bit value of the first setting bit is the second value, the SoC writes the first bit value of the test data into the first functional bit among the multiple functional bits. Thus, the times of programming the OTP memory of the SoC can be reduced. The OTP memory consumption can be reduced. In this way, the test cost of the SoC can be reduced during the test and the development stages.

Although the disclosure has been disclosed above through embodiments, they are not intended to limit the disclosure. Anyone with ordinary knowledge in the relevant technical field can make some changes and modifications without departing from the spirit and scope of the disclosure. Thus, the protection scope of the disclosure shall be determined by the appended claims.

What is claimed is:

1. A System on a Chip, comprising:
a function register, comprising multiple functional bits, wherein the System on a Chip performs a test operation based on data of at least one of the multiple functional bits;
a one-time programmable memory, comprising multiple setting bits and multiple operating bits; and
a processor, coupled to the function register and the one-time programmable memory and configured to receive test data during a test stage,
wherein when a bit value of a first setting bit among the multiple setting bits is a first value, the System on a Chip writes data coming from a first operating bit among the multiple operating bits into a first functional bit among the multiple functional bits, and
wherein when the bit value of the first setting bit is a second value, the System on a Chip writes a first bit value of the test data into the first functional bit among the multiple functional bits.

2. The System on a Chip according to claim 1, further comprising:
a test data memory, coupled to the function register,
wherein in the test stage, when the System on a Chip is reset and the bit value of the first setting bit is the second value, the System on a Chip writes the first bit value of the test data stored in the test data memory into the first functional bit among the multiple functional bits.

3. The System on a Chip according to claim 2, wherein while the System on a Chip is running, the test data that has been written in the test data memory is prohibited from being modified.

4. The System on a Chip according to claim 2, wherein:
while System on a Chip is running, the test data is one-time written into the test data memory, and
the test data memory is initialized based on a power-on procedure of the System on a Chip.

5. The System on a Chip according to claim 1, wherein the System on a Chip receives the test data coming from an external test device.

6. The System on a Chip according to claim 5, wherein the System on a Chip receives the test data based on a transmission protocol.

7. The System on a Chip according to claim 1, wherein when the bit value of the first setting bit is the first value, the System on a Chip performs a logical operation on data coming from a first operating bit group among the multiple operating bits so as to generate the data of the first operating bit.

8. The System on a Chip according to claim 7, further comprising:
a logic circuit, configured to receive the data of the first operating bit group in the test stage and perform an Exclusive OR logical operation on the data of the first operating bit group so as to generate the data of the first operating bit.

9. A test device for testing System on a Chip, wherein the System on a Chip comprises a one-time programmable memory, and wherein the one-time programmable memory comprises multiple setting bits, the test device comprising:
an input unit;
a test data memory;
a processor, coupled to the test data memory, configured to receive multiple test data coming from outside, write the multiple test data into the test data memory, select selected test data from the multiple test data in response to operation of the input unit, and provide the selected test data to the System on a Chip by a transmission protocol,
wherein the System on a Chip receives the selected test data based on the transmission protocol, selects partial bit values of the test data based on bit values of the multiple setting bits, and performs a test operation based on the partial bit values.

10. The test device according to claim 9, further comprising:
a first transmission port, coupled to the processor; and
a second transmission port, coupled to the processor,
wherein the processor receives multiple test data coming from an external device through the first transmission port, and provides the transmission protocol and the selected test data to the System on a Chip through the second transmission port.

11. The test device according to claim 9, wherein:
the processor generates the transmission protocol based on selected test data, and
the transmission protocol comprises a command, a specification signal of the selected test data, and a check signal of the selected test data.

12. The test device according to claim 11, wherein the specification signal represents a quantity of the selected test data and number of bits of the selected test data.

13. The test device according to claim 11, wherein the check signal comprises check information of the selected test data.

14. A test method for testing System on a Chip, wherein the System on a Chip comprises a function register and a one-time programmable memory, wherein the function register comprises multiple functional bits, and wherein the one-time programmable memory comprises multiple setting bits and multiple operating bits, the test methods comprising:
receiving test data by the System on a Chip;
when a bit value of a first setting bit among the multiple setting bits is a first value, writing data coming from a first operating bit among the multiple operating bits into a first functional bit among the multiple functional bits;
when the bit value of the first setting bit is a second value, writing a first bit value of the test data into the first functional bit among the multiple functional bits; and
performing a test operation by the System on a Chip based on data of at least one of the multiple functional bits.

15. The test method according to claim 14, wherein the System on a Chip further comprises a test data memory, the test method further comprising:
in a test stage, when the System on a Chip is reset and the bit value of the first setting bit is the second value, writing the first bit value of the test data stored in the test data memory into the first functional bit among the multiple functional bits.

16. The test method according to claim 15, wherein while the System on a Chip is running, the test data that has been written into the test data memory is prohibited from being modified.

17. The test method according to claim 15, wherein:
while the System on a Chip is running, the test data is one-time written into the test data memory, and
the test data memory is initialized based on a power-on procedure of the System on a Chip.

18. The test method according to claim 14, wherein receiving the test data by the System on a Chip comprises:
receiving the test data coming from an external test device by the System on a Chip based on a transmission protocol,
wherein the transmission protocol comprises a specification signal of the test data and a check signal of the test data.

19. The test method according to claim 18, further comprising:
generating the transmission protocol by the test device based on the test data.

20. The test method according to claim 14, further comprising:
when the bit value of the first setting bit is the first value, performing a logical operation on data coming from a first operating bit group among the multiple operating bits so as to generate the data of the first operating bit.
